(19) United States
(12) Patent Application Publication
(10) Pub. No.: US 2008/0026275 A1
(43) Pub. Date: Jan. 31, 2008

(54) Sol-Gel Derived Composites Comprising Oxide or Oxyhydroxide Matrices With Noble Metal Components and Carbon for Fuel Cell Catalysts

(76) Inventors: Kostantinos Kourtakis, Media, PA (US); Lin Wang, Saraland, AL (US)

Correspondence Address: Gorman, Thomas W.;E.I. Du Pont De Nemours and Company, Legal Patent Records Center, 4417 Lancaster Pike, Wilmington, DE, 19805, US

(21) Appl. No.: 11/579,935

(22) PCT Filed: May 27, 2005
(86) PCT No.: PCT/US05/18989

§ 371 Date: Nov. 9, 2006

Related U.S. Application Data
(60) Provisional application No. 60/575,002, filed on May 27, 2004.

(51) Int. Cl. H01M 8/10

(52) U.S. Cl. 429/33

(57) ABSTRACT

One aspect of this invention is to provide a sol-gel derived composite comprising at least one noble metal and at least one electrically conductive component dispersed in and distributed throughout a matrix comprising titanium silicon sol-gel derived material, zirconium silicon sol-gel derived material, or mixtures thereof. Another aspect of the invention is to provide a process for producing this sol-gel derived composite. Another aspect is to provide a fuel cell and a membrane electrode assembly comprising the sol-gel composite. Another aspect is to provide a process for the deposition of the sol-gel composite on a substrate.

### FIELD OF THE INVENTION

This invention relates to sol-gel derived materials comprising noble metals and an electrically conductive component in a titanium silicon or zirconium silicon oxide or oxyhydroxide matrix.

### BACKGROUND OF THE INVENTION

A fuel cell utilizing a proton (cation) exchange membrane as the electrolyte and employing a direct feed fuel such as methanol, ethanol, dimethoxymethane, or trimethoxymethane and oxygen/air as the oxidant has the capability to replace batteries in small, portable applications. Direct methanol fuel cells are of particular interest for such applications. At the present time, the performance level of direct methanol fuel cells is almost high enough that small cells of this type can be competitive with primary lithium batteries in terms of size and weight. Such fuel cells have several advantages over lithium batteries including (a) the potential for much lighter weight and greater compactness, especially for long-duration operating times, (b) simpler “recharge” involving only the addition of fuel rather than battery replacement, and (c) elimination of disposal issues (quite expensive for lithium batteries) and the need for storage of batteries. U.S. Pat. No. 6,509,112 issued to Luft et al. on Jan. 21, 2003, U.S. Pat. No. 6,660,423 issued to Neutzler et al. on Dec. 9, 2003, and U.S. Pat. No. 6,641,948 issued to Ohlsen et al. on Nov. 4, 2003, provide a general background of direct methanol fuel cells.

Noble metals electrocatalysts, such as platinum-ruthenium electrocatalysts, are used in direct methanol fuel cells. These electrocatalysts are platinum-ruthenium alloys dispersed on high surface area carbons with noble metal concentrations between 5 to 40 weight percent with 1:1 platinum to ruthenium atomic ratio. For industrial applications, other support materials include, for example, aluminum oxide, silicon oxide, and ceramic.

Techniques for making sol-gels are well known in the art (see, e.g., U.S. Pat. No. 5,006,248 issued to Anderson et al. on Apr. 9,1991; U.S. Pat. No. 5,096,745 issued to Anderson et al. on Mar. 17, 1992; U.S. Pat. No. 5,600,535 issued to Jow et al. on Feb. 4, 1997; U.S. Pat. No. 5,914,094 issued to Sun et al. on Jun. 22, 1999). Sol-gel processes offer certain advantages over the conventional high temperature fusion and vapor deposition routes. These advantages include the following: simplicity, ultra-high homogeneity, high purity, narrow particle size distributions, facile routes to multicomponent systems, low energy requirements, and low capital investment.

E. I. Ko, in the Handbook of Heterogeneous Catalysis, ed. by G. Ertl et al., Vol. 1.2.1.4 (1997) reviews generally the use of sol-gel processes for the preparation of catalytic materials.

U.S. Pat. No. 6,689,505 issued to Albers et al. on Feb. 10, 2004, describes the use of an electrocatalyst formed from a carbon support, wherein the catalytically active component is platinum or bi- or multi-metallically doped or alloyed platinum.

U.S. Pat. No. 6,531,304 issued to Bönnemann et al. on Mar. 11, 2003, discloses a process for preparing nanoscale transition metal or alloy colloids having a high dispersibility in different solvents.

U.S. Pat. No. 5,851,947 issued to Hair et al. on Dec. 22, 1998, discloses inorganic aerogels and xerogels containing atomically dispersed noble metals.

### SUMMARY OF THE INVENTION

One aspect of this invention is to provide a sol-gel derived composite comprising at least one noble metal and at least one electrically conductive component dispersed in and distributed throughout a matrix comprising titanium silicon sol-gel derived material, zirconium silicon sol-gel derived material, or mixtures thereof. Preferably, the at least one noble metal comprises platinum, ruthenium, or mixtures thereof, and the at least one electrically conductive component is graphitic carbon powder.

In a preferred embodiment, the sol-gel derived composite has the empirical formula
{[(Pt)ₐ(Ru)_{b}(M)_{1-(a+b)}]_{1-d} [(Tiⁿ_{y}ZrₓSi_{1-x-y})(O₁₋ₑOH₂ₑ)_{z}]_{d}}_{q} [C]ᵣ
wherein n is 3 to 4; x is 0 to 1; y is 0 to 1; x+y>0; z=[4(x+(1−x−y))+n(y)]/2; a is 0.01 to 1; b=0 to 0.99; d is 0.05 to 0.95; e is 0 to 1; M is a promoter element selected from Ni, Co, Fe, W, and Mo; C is the at least one electrically conductive component; q is about 5 wt % to about 90 wt %; and r is 1−q. Preferably, a is 0.5, b is 0.5, x is 0 to 0.5, y is 0 to 0.5, d is 0.5, e is 0 to 1, and q is 40 wt %.

Another aspect of the invention is to provide a process for producing a sol-gel derived composite comprising:
a) combining a first solution comprising at least one noble metal containing compound with a second solution comprising a mixed-metal oxyhydroxide and a solvent to form a mixture;
b) adding a third solution comprising at least one electrically conductive component to the mixture; and
c) polymerizing the mixture to form an inorganic gel.

Another aspect of the invention is to provide a fuel cell comprising a chamber, a membrane separating the chamber into an anode compartment and a cathode compartment, wherein the membrane is at least partially coated with a catalyst comprising a sol-gel derived composite comprising at least one noble metal and at least one electrically conductive component dispersed in and distributed throughout a matrix comprising titanium silicon sol-gel derived material, zirconium silicon sol-gel derived material, or mixtures thereof.

Another aspect of the invention is to provide a membrane electrode assembly comprising:
a) a first electrode;
b) a second electrode; and
c) a solid polymer electrolyte membrane interposed between the first and second electrode;
   wherein a sol-gel derived composite comprising at least one noble metal and at least one electrically conductive component dispersed in and distributed throughout a matrix comprising titanium silicon sol-gel derived material, zirconium silicon sol-gel derived material, or mixtures thereof is disposed at the interface between the first electrode and the solid polymer electrolyte membrane.

Other objects and advantages of the present invention will become apparent to those skilled in the art upon reference to the detailed description that hereinafter follows.

### DETAILED DESCRIPTION OF THE INVENTION

Applicants specifically incorporate the entire content of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

In the context of this disclosure, a number of terms shall be utilized.

A “sol-gel technique” is a process wherein a free flowing fluid solution, “sol,” is first prepared by dissolving suitable precursor materials such as colloids, alkoxides, or metal salts in a solvent. The “sol” is then dosed with a reagent to initiate reactive polymerization of the precursor. A typical example is tetraethoxyorthosilicate dissolved in ethanol. Water, with trace acid or base as catalyst to initiate hydrolysis, is added. As polymerization and crosslinking proceeds, the free flowing “sol” increases in viscosity and can eventually set to a rigid “gel.” The “gel” comprises a cross-linked network of the desired material that encapsulates the original solvent within its open porous structure.

A gel may be described as a coherent, rigid three-dimensional polymeric network. The present gels are formed in a liquid medium, usually water, alcohol, or a mixture thereof. The term “alcogel” describes gels in which the pores are filled with predominantly alcohol. Gels whose pores are filled primarily with water may be referred to as aquagels or hydrogels.

A “xerogel” is a gel from which the liquid medium has been removed and replaced by a gas. In general, the structure is compressed and the porosity reduced significantly by the surface tension forces that occur as the liquid is removed. As soon as liquid begins to evaporate from a gel at temperatures below the critical temperature, surface tension creates concave menisci in the gel's pores. As evaporation continues, the menisci retreat into the gel body, compressive forces build up around its perimeter, and the perimeter contracts, drawing the gel body inward. Eventually surface tension causes significant collapse of the gel body and a reduction of volume, often as much as two-thirds or more of the original volume. This shrinkage causes a significant reduction in the porosity, often as much as 90 to 95 percent depending on the system and pore sizes.

In contrast, an “aerogel” is a gel from which the liquid has been removed in such a way as to prevent significant collapse or change in the structure as liquid is removed. This is typically accomplished by heating the liquid-filled gel in an autoclave while maintaining the prevailing pressure above the vapor pressure of the liquid until the critical temperature of the liquid has been exceeded, and then gradually releasing the vapor, usually by gradually reducing the pressure either incrementally or continuously, while maintaining the temperature above the critical temperature. The critical temperature is the temperature above which it is impossible to liquefy a gas, regardless of how much pressure is applied. At temperatures above the critical temperature, the distinction between liquid and gas phases disappears and so do the physical manifestations of the gas/liquid interface. In the absence of an interface between liquid and gas phases, there is no surface tension and hence no surface tension forces to collapse the gel. Such a process may be termed “supercritical drying.” Aerogels produced by supercritical drying typically have high porosities, on the order of from 50 to 99 percent by volume.

The “gel” may then be dried, typically by either simple heating in a flow of dry air to produce a xerogel or the entrapped solvent may be removed by displacement with a supercritical fluid such as liquid CO₂ to produce an aerogel. These aerogels and xerogels may be optionally calcined at elevated temperatures resulting in products that typically have very porous structures and concomitantly high surface areas.

The term “matrix” as used herein means a skeletal framework of oxyhydroxides derived from the hydrolysis and condensation of alkoxides and other reagents. As discussed below, porosity and microstructure can be controlled, in some cases, by synthetic parameters (for example, pH and temperature), drying, and other heat conditioning. As used herein, the term “microstructure” means a description, both physical and chemical in nature, of the bonding of domains and crystallites with each other and their arrangement and physical appearance or morphology in a matrix or solid. Microstructure also describes the structure and morphology, that is bonding and physical appearance, of the other active cationic precursors that are included in this invention.

The term “noble metal” as used herein means elemental metals that are highly resistant to corrosion and/or oxidation. Noble metals include, for example, ruthenium, rhodium, palladium, silver, rhenium, osmium, iridium, platinum, and gold. Preferable noble metals include platinum, ruthenium, and mixtures thereof.

The term “electrically conductive component” as used herein can include particulate carbons, conducting polymers such as polyaniline or polypyrrole, conducting transition metal carbides, conducting metal oxide bronzes, and other conducting carbons. Preferred carbons are turbostratic or graphitic carbons of varying surface areas such as Vulcan® XC72R (available from Cabot Corp., Alpharetta, Ga.), Ketjenblack® EC-600JD or EC-300J (available from Akzo Nobel Inc., Chicago, Ill.), Black Pearls® (available from Cabot Corp.), acetylene black (available as Denka® Black from Denki Kagku Kogyo Kabushiki Kaisha, Tokyo, Japan), as well as other conducting carbon varieties. Other carbons include carbon fibers, single- or multi-wall carbon nanotubes, and other carbon structures (e.g., fullerenes and nanohorns). Preferable electrically conductive components include Vulcan® XC72R and Ketjenblack® EC-600JD.

In one embodiment, a sol-gel derived composite comprises at least one noble metal and at least one electrically conductive component dispersed in and distributed throughout a matrix comprising titanium silicon sol-gel derived material, zirconium silicon sol-gel derived material, or mixtures thereof. Alternatively, the at least one noble metal and at least one electrically conductive component may be referred to as being “matrix incorporated.”

By virtue of the synthetic methods, the electrically conductive component is present as a composite within the titanium, zirconium, or silicon matrix (or their combination). The noble metal component is incorporated in the pore structure of the sol-gel derived matrix contain titanium, zirconium, titanium-silicon, zirconium silicon, titanium zirconium silicon oxides or oxyhydroxides, or mixtures thereof.

Preferably, the at least one noble metal comprises platinum, ruthenium, or mixtures thereof.

The sol-gel derived composites may be prepared by one-step synthesis of alcogels in which hydrolyzable matrix precursors are used in the presence of soluble metal salts and an electrically conductive component. This preparative process is characterized by combining a first solution comprising at least one noble metal containing compound with a second solution comprising a metal alkoxide, an orthosilicate, and a solvent to form a mixture; adding a third solution comprising at least one electrically conductive component to the mixture; and polymerizing the mixture to form an inorganic gel. The order of addition of reagents, nature of precursors and solvents, and the nature of gelling agents may be varied widely. The term “gelling agent” means a reagent that causes or facilitates the formation of a gel. The gelling agent may be acidic, basic, or neutral, such as, for example, water.

Preferably, the sol-gel derived composite comprises the formula {[(Pt)ₐ(Ru)_{b}(M)_{1-(a+b)}]_{1-d} [(Tiⁿ_{y}ZrₓSi_{1-x-y})(O₁₋ₑOH₂ₑ)_{z}]_{d}}_{q} [C]ᵣ, wherein n, representing the oxidation state of Ti, is 3 to 4; x is 0 to 1; y is 0 to 1; x+y>0; z=[4(x+(1−x−y))+n(y)]/2; a is 0.01 to 1; b=0 to 0.99; d is 0.05 to 0.95; e is 0 to 1; M is a promoter element selected from Ni, Co, Fe, W, and Mo; C is the electrically conductive component; q, representing weight percent, is about 5 wt % to about 90 wt %; and r, representing weight percent, is 1−q. Weight percent is based on the total weight of all components of the sol-gel derived composite.

In a preferred embodiment, a is 0.5, b is 0.5, x is 0 to 0.5, y is 0 to 0.5, d is 0.5, e is 0 to 1, and q is 40 wt %.

One or more metal alkoxides (e.g., titanium n-butoxide; tetraethylorthosilicate) may be used as starting material for preparing the gels. The inorganic metal alkoxides used herein may include any alkoxide that contains from 1 to 20 carbon atoms and preferably contains 1 to 5 carbon atoms in the alkoxide group, and is preferably are soluble in the liquid reaction medium. C₁-C₄ alkoxides such as titanium n-butoxide and zirconium n-propoxide, and tetraethylorthosilicate are preferred.

Commercially available alkoxides can be used. However, inorganic alkoxides can be prepared by other routes. Examples include alkoxides prepared by the direct reaction of zero valent metals with alcohols in the presence of a catalyst. Many alkoxides can be formed by reaction of metal halides with alcohols. Alkoxy derivatives can be synthesized by the reaction of the alkoxide with alcohol in a ligand interchange reaction. Direct reactions of metal dialkylamides with alcohol also form alkoxide derivatives. Additional examples are disclosed in “Metal Alkoxides” by D. C. Bradley et al., Academic Press, (1978).

The first step in the synthesis of the gels containing alcohol, or alcogels, consists of preparing non-aqueous solutions of the alkoxides and other reagents, and separate solutions containing protic solvents such as water.

Soluble noble metal salts such as platinum chloride and ruthenium chloride can be added to the non-aqueous alkoxide solution. Alternatively, soluble platinum salts can be added to the aqueous solution. Addition of the noble metal salts to the alkoxide solution is preferred.

The electrically conductive component such as the carbon, metal oxide bronze, or other conducting additive can be added to either the aqueous or non-aqueous solution containing the alkoxide species. Addition of the electrically conductive component to the non-aqueous solution is preferred.

When the alkoxide solutions are mixed with the solutions containing the protic solvents, the alkoxides will react and polymerize to form a gel.

The medium utilized in the process generally is preferably a solvent for both the inorganic alkoxide or alkoxides that are used and the additional metal reagents and promoters that are added in the single step synthesis. Solubility of all of the components in their respective media (aqueous and non-aqueous) is preferred to produce highly dispersed materials. By employing soluble reagents in this manner, mixing and dispersion of the active metals and promoter reagents can be near atomic, mirroring their dispersion in their respective solutions. The gel thus produced by this process will therefore contain highly dispersed active noble metals. High dispersion results in catalyst metal particles in the nanometer size range, and highly efficient use of the catalytically active components.

Typically, the concentration of the solvent used is linked to the alkoxide content. A molar ratio of 26.5:1 ethanol:total alkoxide can be used, although the molar ratio of ethanol:total alkoxide can be from about 5:1 to 53:1, or even greater. If a large excess of alcohol is used, gelatin will not generally occur immediately; some solvent evaporation will be needed. At lower solvent concentrations, it is thought that a heavier gel will be formed, having less pore volume and surface area.

For this invention, water and any aqueous solutions are added in a dropwise fashion to the alcohol soluble alkoxide and other reagents to induce hydrolysis and condensation reaction. Depending on the alkoxide system, a discernible gel point can be reached in minutes or hours. The molar ratio of the total water added to the total Zr, Ti, and Si alkoxide in the non-aqueous solution (including water present in aqueous solutions) varies according to the specific inorganic alkoxide being reacted.

Generally, a molar ratio of water:alkoxide from about of 0.1:1 to 10:1 is used. For example, ratios close to 4:1 for zirconium(alkoxide)₄ and titanium(alkoxides)₄ can be used. The amount of water utilized in the reaction is that calculated to hydrolyze the inorganic alkoxide in the reaction mixture. A ratio lower than that needed to hydrolyze the alkoxide species will result in a partially hydrolyzed material, which in most cases will reach a gel point at a much slower rate, depending on the aging procedure and the presence of atmospheric moisture.

The addition of acidic or basic reagents to the inorganic alkoxide medium can have an effect on the kinetics of the hydrolysis and condensation reactions, and the microstructure of the oxide/hydroxide matrices derived from the alkoxide precursor that entraps or incorporates the soluble metal and promoter reagents. Generally, a pH within the range of from 1 to 12 can be used, with a pH range of from 1 to 6 being preferred.

After reacting to form the gels of the present invention, it may be necessary to complete the gelatin process with some aging of the gel. This aging can range form one minute to several days. In general, all alcogels are aged at room temperature in air for at least several hours.

Removal of solvent from the alcogels can be accomplished by several methods. Removal by vacuum drying or heating in air results in the formation of a xerogel. An aerogel of the material can typically be formed by charging in a pressurized system such as an autoclave. The solvent-containing gel that is formed in the practice of this invention is placed in an autoclave, where it can be contacted with a fluid above its critical temperature and pressure by allowing the supercritical fluid to flow through the gel material until the solvent is no longer being extracted by the supercritical fluid. In performing this extraction to produce an aerogel material, various supercritical fluids can be utilized at their critical temperature and pressure. For instance, fluorochlorocarbons typified by Freon® fluorochloromethanes (e.g., Freon® 11 (CCl₃F), 12 (CCl₂F₂), or 114 (CClF₂CClF₂)), ammonia, and carbon dioxide are all suitable for this process. Typically, the extraction fluids are gases at atmospheric conditions, so that pore collapse due to the capillary forces at the liquid/solid interface is avoided during drying. The resulting material will, in most cases, possess a higher surface area than the non-supercritically dried materials.

The xerogels and aerogels thus produced can be described as precursor salts dispersed in an oxide or oxyhydroxide matrix. The hydroxyl content is at this point undefined; a theoretical maximum corresponds to the valence of central metal atom. Hence, Ti(O₂₋ₓ(OH)ₓ) possesses a theoretical hydroxyl maximum when x is 2. The molar H₂O:alkoxide ratio can also impact the final xerogel stoichiometry; in this case, if H₂O:Ti is less than 4, there will be residual —OR groups in the unaged gel. However, reaction with atmospheric moisture will convert these to the corresponding —OH, and —O groups upon continued polymerization and dehydration. Aging, even under inert conditions, can also effect the condensation of the —OH, eliminating H₂O, through continuation of cross-linking and polymerization, i.e., gel formation.

The noble metal components (e.g., platinum, ruthenium, and mixtures thereof) can exist as the reduced metal, oxide, or oxyhydroxide.

Normally, the catalytic metal component of the matrix is reduced, in some cases in situ (during electrochemical evaluations) or ex situ to provide elemental metal (e.g., platinum) before use. Ex situ reduction can be accomplished using various reductants, such as H₂ gas at elevated temperatures, or by using chemical reductants such as sodium borohydride, hydrazine, or hypophosphorus acid.

The amount of noble metal present in the catalyst may vary widely, as indicated by the formula {[(Pt)ₐ(Ru)_{b}(M)_{1-(a+b)}]_{1-d} [(Tiⁿ_{y}ZrₓSi_{1-x-y})(O₁₋ₑOH₂ₑ)_{z}]_{d}}_{q} [C]ᵣ, wherein n, representing the oxidation state of Ti, is 3 to 4; x is 0 to 1; y is 0 to 1; x+y>0; z=[4(x+(1−x−y))+n(y)]/2; a is 0.01 to 1; b=0 to 0.99; d is 0.05 to 0.95; e is 0 to 1; M is a promoter element selected from Ni, Co, Fe, W, and Mo; C is the electrically conductive component; q, representing weight percent, is about 5 wt % to about 90 wt %; and r, representing weight percent, is 1−q. Weight percent is based on the total weight of all components of the sol-gel derived composite. Preferably, a is 0.5, b is 0.5, x is 0 to 0.5, y is 0 to 0.5, d is 0.5, e is 0 to 1, and q is 40 wt %.

An illustrative preparation involves the incorporation of platinum or ruthenium salts, or mixtures thereof, in an oxyhydroxide solution of titanium/silicon or zirconium/silicon. The hydrolysis of alkoxides to form oxides or oxyhydroxides can either be acid or base catalyzed. Hydrolysis of the oxyhydroxide precursors is accompanied by condensation reactions.

Under conditions known in the art (pH, gelling agent, reactant ratios, temperature, time, solvent, and solvent concentration), these can result in the polymerization into an inorganic gel containing the desired noble metals and electrically conductive components. In some cases, the noble metals are either part of the polymerization network or are entrapped within the network.

A consequence of this method is that higher metal dispersion and uniformity can be achieved in the oxyhydroxide matrix than is normally attainable using more conventional synthetic methods.

Gel precursors are prepared from oxyhydroxides and other reagents and separate solutions containing protic solvents, such as water. Oxyhydroxide precursor solutions are mixed with the solutions containing the protic solvent, and the oxyhydroxides will react and polymerize to form a gel. The protic solvent can include water, with trace acid or base as catalyst to initiate hydrolysis. As polymerization and crosslinking proceeds, viscosity increases and the material can eventually set to a rigid gel.

In the preparation of the sol-gel derived composites, the noble metal precursors and the electrically conductive components can be added separately or to the protic or the oxyhydroxide precursor containing solutions. After gelatin, the metal salt or complex is uniformly incorporated into the gel network. The gel may then be dried and heated to produce xerogel or aerogel materials, as described below.

Because of the synthetic technique and the physical appearance of the alcogel materials produced, it is clear that the precursor xerogels and aerogels contain active metals and promoters in a highly dispersed state. Further processing to produce the final catalytic material may include chemical reduction at low temperatures to produce the final highly dispersed material, or a combination of heating cycles in various media, including hydrogen, to produce the final active catalyst.

One of the criteria for the starting material (preferably titanium or zirconium alkoxides or metal salts) is that they will dissolve in the specified medium or solvent. Preferably, commercially available alkoxides can be used. However, titanium or zirconium alkoxides can be prepared by other routes. Some examples include direct reaction of zero valent metals with alcohols in the presence of a catalyst. Many alkoxides can be formed by reaction of metal halides with alcohols. Alkoxy derivatives can be synthesized by the reaction of the alkoxide with alcohol in a ligand interchange reaction. Direct reaction of dialkylamides with alcohol also forms alkoxide derivatives. The medium utilized in the process generally should be a solvent for the titanium or zirconium alkoxide or alkoxides that are utilized and the additional metal reagents and promoters that are added in the single step synthesis. Solubility of all components in their respective media (aqueous and non-aqueous) is preferred to produce highly dispersed materials. By employing soluble reagents in this manner, mixing and dispersion of the active metals and promoter reagents can be near atomic, in fact mirroring their dispersion in their respective solutions. The sol-gel thus produced by this process has highly dispersed active metals and promoters. High dispersion results in precursor particles in the nanometer size range or smaller.

In another aspect, the sol-gel derived composite is dried to form an electro-catalyst powder. The catalyst powders can be coated on a substrate. For example, electrochemical fuel cells employ an electrolyte disposed between two electrodes, namely a cathode and an anode. Solid polymer fuel cells generally employ a membrane electrode assembly in which the electrolyte comprises a solid polymer electrolyte (“SPE”), which is an ion exchange membrane, disposed between the two electrode layers comprising porous, electrically conductive sheet material. The SPE is ion conductive (typically proton conductive), and also acts as a barrier for isolating the reactant streams from each other. Another function of the membrane is to act as an electrical insulator between the two electrode layers. An electrocatalyst is disposed at the interface between the SPE and the electrodes to induce the desired electrochemical reactions. Thus, an electro-oxidation catalyst is used at the interface between the SPE and the anode, and an electro-reduction catalyst is used at the interface between the SPE and the cathode.

Electrocatalyst powders comprising a sol-gel derived composite comprising at least one noble metal and at least one electrically conductive component are particularly well suited as electro-oxidation catalysts in a fuel cell. Thus, in accordance with another embodiment, the electrocatalyst can be applied to the surface of the SPE that faces the anode, to the surface of the anode facing the SPE, or to both surfaces. In an alternative embodiment, the electrocatalyst is coated on the surfaces of both electrodes facing the SPE, both surfaces of the SPE, or a combination thereof. In accordance with another aspect, the substrate comprises a SPE. In accordance with a further aspect, the substrate comprises an electrode, preferably an anode.

In one embodiment of the invention, the geometric surface of catalyst on the electrode can be as low as 0.1 mg Pt/cm² depending on the fuel and/or power requirements of the fuel cell. In an alternative embodiment, the geometric surface of catalyst on the electrode can be as high as 4 mg Pt/cm² or more depending on the fuel and/or power requirements of the fuel cell.

In accordance with another aspect of the present invention, a fuel cell, preferably a direct methanol fuel cell, comprises a chamber and a membrane separating the chamber into an anode compartment and a cathode compartment, wherein the membrane is at least partially coated with a catalyst comprising a sol-gel derived composite comprising at least one noble metal and at least one electrically conductive component. Preferably, the membrane comprises a first surface facing the anode chamber and a second surface facing the cathode chamber and the catalyst is at least partially coated on the first surface. Further, the fuel cell according to this aspect of the invention can be part of a fuel stack comprising at least two fuel cells. While as few as one fuel cell of the fuel stack can comprise the sol-gel derived composite, preferably all of the fuel cells in the fuel stack comprise the sol-gel derived composite.

When the sol-gel derived composite is used as an electrocatalyst coating composition, it is preferable to adjust the amounts of anode electrocatalyst, ion exchange polymer, and other components, if present, so that the anode electrocatalyst is the major component by weight of the resulting electrode. More preferably, the weight ratio of anode electrocatalyst to ion exchange polymer in the electrode is about 2:1 to about 10:1.

Known electrocatalyst coating techniques can be used and will produce a wide variety of applied layers of essentially any thickness ranging from very thick, e.g., 20 μm or more to very thin, e.g., 1 μm or less.

The substrate for use in preparing a catalyst-coated membrane (“CCM”) can be a membrane of the same ion exchange polymers discussed above for use in the electrocatalyst coating compositions. The membranes can be made by known extrusion or casting techniques and have thicknesses that can vary depending upon the intended application. The membranes typically have a thickness of 350 μm or less, although recently membranes that are quite thin, i.e., 50 μm or less, are being employed. While the polymer can be in alkali metal or ammonium salt form, it is typical for the polymer in the membrane to be in acid form to avoid post treatment acid exchange steps. Suitable perfluorinated sulfonic acid polymer membranes in acid form are available under the trademark Nafion® by E.I. du Pont de Nemours and Company.

Reinforced perfluorinated ion exchange polymer membranes can also be utilized in CCM manufacture. Reinforced membranes can be made by impregnating porous, expanded polytetrafluoroethylene (“ePTFE”) with ion exchange polymer. ePTFE is available under the trade name “Goretex” from W. L. Gore and Associates, Inc. (Elkton, Md.) and under the trade name “Tetratex” from Tetratec (Feasterville, Pa.). Impregnation of ePTFE with perfluorinated sulfonic acid polymer is disclosed in U.S. Pat. No. 5,547,551 issued to Bahar et al. on Aug. 20, 1996, and U.S. Pat. No. 6,110,333 issued to Spethmann et al. on Aug. 29, 2000.

Alternately, the ion exchange membrane can be a porous support. A porous support may improve mechanical properties for some applications and/or decrease costs. The porous support can be made from a wide range of components, including hydrocarbons and polyolefins, e.g., polyethylene, polypropylene, polybutylene, copolymers including polyolefins, and the like. Perhalogenated polymers such as polychlorotrifluoroethylene can also be used. The membrane can also be made from a polybenzimadazole polymer, for example, by casting a solution of polybenzimadazole in phosphoric acid (H₃PO₄) doped with trifluoroacetic acid (“TFA”) as described in U.S. Pat. No. 5,525,436 issued to Savinell et al. on Jun. 11, 1996, U.S. Pat. No. 5,716,727 issued to Savinell et al. on Feb. 10, 1998, U.S. Pat. No. 6,025,085 issued to Savinell et al. on Feb. 15, 2000, and U.S. Pat. No. 6,099,988 issued to Savinell et al. on Aug. 8, 2000.

The gas diffusion backing comprises a porous, conductive sheet material such as paper or cloth, made from a woven or non-woven carbon fiber, that can be treated to exhibit hydrophilic or hydrophobic behavior, and a gas diffusion layer, typically comprising a film of carbon particles and fluoropolymers such as PTFE. The electrocatalyst coating composition is coated onto the gas diffusion backing. The electrocatalyst coating composition that forms the anode or cathode is the same as that described hereinabove for use in making the catalyst coated membrane.

An assembly including the membrane and gas diffusion backings with the electrocatalyst composition coated either on the membrane or the gas diffusion backings or on both is sometimes referred to as a membrane electrode assembly (“MEA”). Bipolar separator plates, made of a conductive material and providing flow fields for the reactants, are placed between a number of adjacent MEAs. A number of MEAs and bipolar plates are assembled in this manner to provide a fuel cell stack.

For the electrodes to function effectively in the fuel cells, effective anode and cathode electrocatalyst sites are provided. Effective anode and cathode electrocatalyst sites have several desirable characteristics: (1) the sites are accessible to the reactant, (2) the sites are electrically connected to the gas diffusion layer, and (3) the sites are ionically connected to the fuel cell electrolyte.

It is desirable to seal reactant fluid stream passages in a fuel cell stack to prevent leaks or inter-mixing of the fuel and oxidant fluid streams. Fuel cell stacks typically employ fluid tight resilient seals, such as elastomeric gaskets between the separator plates and membranes. Such seals typically circumscribe the manifolds and the electrochemically active area. Sealing can be achieved by applying a compressive force to the resilient gasket seals. Compression enhances both sealing and electrical contact between the surfaces of the separator plates and the MEAs, and sealing between adjacent fuel cell stack components. In conventional fuel cell stacks, the fuel cell stacks are typically compressed and maintained in their assembled state between a pair of end plates by one or more metal tie rods or tension members. The tie rods typically extend through holes formed in the stack end plates, and have associated nuts or other fastening means to secure them in the stack assembly. The tie rods may be external, that is, not extending through the fuel cell plates and MEAs; however, external tie rods can add significantly to the stack weight and volume. It is generally preferable to use one or more internal tie rods that extend between the stack end plates through openings in the fuel cell plates and MEAs as described in U.S. Pat. No. 5,484,666 issued to Gibb et al. on Jan. 16, 1996. Typically resilient members are utilized to cooperate with the tie rods and end plates to urge the two end plates towards each other to compress the fuel cell stack.

The resilient members accommodate changes in stack length caused by, for example, thermal or pressure induced expansion and contraction, and/or deformation. That is, the resilient member expands to maintain a compressive load on the fuel cell assemblies if the thickness of the fuel cell assemblies shrinks. The resilient member may also compress to accommodate increases in the thickness of the fuel cell assemblies. Preferably, the resilient member is selected to provide a substantially uniform compressive force to the fuel cell assemblies, within anticipated expansion and contraction limits for an operating fuel cell. The resilient member can comprise mechanical springs, or a hydraulic or pneumatic piston, or spring plates, or pressure pads, or other resilient compressive devices or mechanisms. For example, one or more spring plates can be layered in the stack. The resilient member cooperates with the tension member to urge the end plates toward each other, thereby applying a compressive load to the fuel cell assemblies and a tensile load to the tension member.

### EXAMPLES

The present invention is further defined in the following Examples. It should be understood that these Examples, while indicating preferred embodiments of the invention, are given by way of illustration only. From the above discussion and these Examples, one skilled in the art can ascertain the preferred features of this invention, and without departing from the spirit and scope thereof, can make various changes and modifications of the invention to adapt it to various uses and conditions.

The meaning of abbreviations is as follows: “h” means hour(s), “min” means minute(s), “S” means second(s), “mL” means milliliter(s), “g” means gram(s), “mg” means milligram(s), “M” means molar, “cm” means centimeter(s), “mA” means milliampere(s), “V” means volt(s), and “wt %” means weight percent(age).

### Example 1

In an inert atmosphere drybox, 3.0957 g of platinum tetrachloride (PtCl₄; Alfa Aesar, Ward Hill, Mass.) were combined with 2.033 g of ruthenium chloride hydrate (RuCl₃×H₂O; Ru content=45.6 wt %; Sigma-Aldrich, St. Louis, Mo.) and 800 mL of punctilious ethanol. A second solution was prepared by combining 3.1224 g titanium n-butoxide (Sigma-Aldrich) with 1.911 g of tetraethylorthosilicate (Sigma-Aldrich) and 50 mL of punctilious ethanol. In an inert atmosphere drybox, the second solution was added to the first solution with stirring. 6 g of Vulcan® XC72R (carbon black, Cabot Corp., Alpharetta, Ga.) were added approximately 10 S later.

After about 5 min, 1.32 g of H₂O were added to the solution. The solution was mildly stirred and blanketed with nitrogen. After about 72 h, the material was dried under vacuum at 100° C. for 5 h.

The dried powder was reduced by first wetting 7 g of the catalyst powder with 20 g of water. 37.4869 g of NaBH₄ in 14 M NaOH were then contacted with the powder at room temperature. The powder was subsequently washed several times to remove residual Na and other contaminants from the reductant.

The catalyst was then prepared as an ink for electrochemical half-cell measurements. 0.2158 g of the catalyst, 0.4065 g of aqueous Nafion® Ionomer Solution (perfluorosulfonic acid/polytetrafluoroethylene copolymer, 10.62 wt %, hydrogen form; E. I. du Pont de Nemours & Co., Wilmington, Del.), and 5.3775 g of H₂O were milled in an Omni Mixer Homogenizer at room temperature for 30 min. The ink was then coated onto carbon paper strips over a 1.5-cm2 area so that the final geometric surface of catalyst on the strip is approximately 0.3 mg Pt/1.5 cm². The entire strip, which is 1.0×5.5 cm², was heated in flowing hydrogen at 120° C. for 1 h prior to measurement.

### Example 2

The same procedure was used as described in Example 1, except that instead of reducing the catalyst powder in NaBH₄, the powder was reduced in flowing H₂ to 120° C. for 1 h.

The catalyst was then prepared as an ink for electrochemical half-cell measurements. 0.1829 g of the catalyst, 0.3445 g of aqueous Nafion® Ionomer Solution (10.62 wt %, hydrogen form; E. I. du Pont de Nemours & Co.), and 5.4726 g of H₂O were milled in an Omni Mixer Homogenizer at room temperature for 30 min. The ink was then coated onto carbon paper strips over a 1.5-cm2 area so that the final geometric surface of catalyst on the strip is approximately 0.3 mg Pt/1.5 cm². The entire strip, which is 1.0×5.5 cm², was heated in flowing hydrogen at 120° C. for 1 h prior to measurement.

### Example 3

A similar procedure as described in Example 2 was employed. 4.077 g of PtCl₄ (Alfa Aesar) were combined with 2.6765 g of RuCl₃×H₂O (Ru content=45.6 wt %; Sigma-Aldrich) and 600 mL of punctilious ethanol in an inert atmosphere drybox. A second solution containing 1.028 g of titanium n-butoxide (Sigma-Aldrich), 0.629 g of tetraethylorthosilicate (Sigma-Aldrich) and 100 mL of punctilious ethanol was prepared. In an inert atmosphere drybox, the second solution was added to the first, and immediately thereafter 6 g of Vulcan® XC72R (Cabot Corp.) were mixed in. 0.4535 g of H₂O was added to this mixture to initiate condensation and the polymerization reaction.

All subsequent steps are the same as described in Example 2. The catalyst was then prepared as an ink for electrochemical half-cell measurements. 0.1569 g of the catalyst, 0.2955 g of aqueous Nafion® Ionomer Solution (10.62 wt %, hydrogen form; E. I. du Pont de Nemours & Co.), and 5.5476 g of H₂O were milled in an Omni Mixer Homogenizer at room temperature for 30 min. The ink was then coated onto carbon paper strips over a 1.5-cm2 area so that the final geometric surface of catalyst on the strip is approximately 0.3 mg Pt/1.5 cm². The entire strip, which is 1.0×5.5 cm², was heated in flowing hydrogen at 120° C. for 1 h prior to measurement.

### Example 4

A procedure similar to that described in Example 2 was used. 2.816 g of PtCl₄ (Alfa Aesar) were mixed with 1.8492 g of RuCl₃×H₂O (Ru content=45.6 wt %; Sigma-Aldrich) and 600 mL of punctilious ethanol in an inert atmosphere drybox. A second solution was prepared by mixing 1.4684 g of zirconium n-propoxide (70 wt % in ethanol; Alfa Aesar), 1.7388 g of tetraethylorthosilicate (Sigma-Aldrich), and 20 mL of punctilious ethanol. The second solution was added to the first solution in the inert atmosphere drybox. Immediately thereafter, 6 g of Vulcan® XC72R (Cabot Corp.) were added to the solution, and approximately 5 min thereafter 1.2 g of H₂O were added to the mixture to initiate hydrolysis and condensation reactions. All subsequent procedures are identical to those described in Example 2.

The catalyst was then prepared as an ink for electrochemical half-cell measurements. 0.2166 g of the catalyst and 0.4079 g of aqueous Nafion® Ionomer Solution (10.62 wt %, hydrogen form; E. I. du Pont de Nemours & Co.), and 5.3755 g of H₂O were milled in an Omni Mixer Homogenizer at room temperature for 30 min. The ink was then coated onto carbon paper strips over a 1.5-cm2 area so that the final geometric surface of catalyst on the strip is approximately 0.3 mg Pt/1.5 cm². The entire strip, which is 1.0×5.5 cm², was heated in flowing hydrogen at 120° C. for 1 h prior to measurement.

### Example 5

### Electrochemical Data: Peak Oxidation Currents

TABLE 1
Half Cell Measurements Showing the Electroactivity
for Methanol electrooxidation

| | ipt1 | mA/mg Pt |
|---|---|---|
| Example 1 | 272 | 278 |
| Example 2 | 240 | 246 |
| Example 3 | 229 | 217 |
| Example 4 | 227 | 200 |

An Arbin Testing System Station manufactured by Arbin Instruments (Model BT2043, Software Version MITS'97) was used to collect the electrochemical half-cell data. The electrodes were evaluated for their activity for methanol oxidation using cyclic voltametry (CV) in a 1 M CH₃OH/0.5 M H₂SO₄ solution using a 3-electrode system where the counter electrode was a Pt coil, and a SCE (standard calomel electrode) was used as the reference electrode. The potential was scanned from the open circuit potential (Eoc) to 1.1 V and back to −0.25 V at a scan rate of 50 mV/S. The scans were repeated from 1.1 V to −0.25 V to 1.1 V until the current is stable. The currents were normalized for geometric surface area. The current tabulated is ipt1, which is the peak oxidation current from the CV scan in mA/cm², the current in mA divided by the geometric electrode area of 1.5 cm². ipt1A is the peak oxidation current from the CV scan normalized to the amount of Pt (in mg) on the catalyst strips.

The data indicates that these materials can be used as electrodes, specifically direct methanol fuel cell anodes.

What is claimed is:

1. A sol-gel derived composite comprising at least one noble metal and at least one electrically conductive component dispersed in and distributed throughout a matrix comprising titanium silicon sol-gel derived material, zirconium silicon sol-gel derived material, or mixtures thereof.

2. The sol-gel derived composite of claim 1, wherein the at least one noble metal comprises platinum, ruthenium, or mixtures thereof.

3. The sol-gel derived composite of claim 2 having the formula
{[(Pt)ₐ(Ru)_{b}(M)_{1-(a+b)}]_{1-d} [(Tiⁿ_{y}ZrₓSi_{1-x-y})(O₁₋ₑOH₂ₑ)_{z}]_{d}}_{q} [C]ᵣ
wherein n is 3 to 4;
x is 0 to 1;
y is 0 to 1;
x+y>0;
z=[4(x+(1−x−y))+n(y)]/2;
a is 0.01 to 1;
b=0 to 0.99;
d is 0.05 to 0.95;
e is 0 to 1;
M is a promoter element selected from Ni, Co, Fe, W, and Mo;
C is the at least one electrically conductive component;
q is about 5 wt % to about 90 wt %; and
r is 1−q.

4. The sol-gel derived composite of claim 3, wherein a is 0.5.

5. The sol-gel derived composite of claim 3, wherein b is 0.5.

6. The sol-gel derived composite of claim 3, wherein x is 0 to 0.5.

7. The sol-gel derived composite of claim 3, wherein y is 0 to 0.5.

8. The sol-gel derived composite of claim 3, wherein d is 0.5.

9. The sol-gel derived composite of claim 3, wherein q is 40 wt %.

10. The sol-gel derived composite of claim 1, wherein the at least one electrically conductive component comprises turbostratic or graphitic carbon.

11. An article comprising the sol-gel derived composite of claim 1.

12. A substrate coated with the sol-gel derived composite of claim 1.

13. A process for producing a sol-gel derived composite comprising:
a) combining a first solution comprising at least one noble metal containing compound with a second solution comprising a metal alkoxide, an orthosilicate, and a solvent to form a mixture;
b) adding a third solution comprising at least one electrically conductive component to the mixture; and
c) polymerizing the mixture to form an inorganic gel.

14. The process of claim 13, wherein the at least one noble metal containing compound comprises platinum, ruthenium, or mixtures thereof.

15. The process of claim 13, wherein the at least one electrically conductive component comprises turbostratic or graphitic carbon.

16. The process of claim 13, wherein the metal alkoxide comprises a titanium alkoxide or a zirconium alkoxide.

17. The process of claim 13, wherein the metal alkoxide is a metal ethoxide, a metal n-butoxide, a metal isopropoxide, or a metal n-propoxide.

18. The process of claim 17, wherein the metal alkoxide is titanium n-butoxide or zirconium n-propoxide.

19. The process of claim 13, wherein the orthosilicate is tetraethylorthosilicate.

20. The process of claim 13, wherein a gelling agent facilitates the polymerizing step.

21. The process of claim 20, wherein the gelling agent is water.

22. The process of claim 21, wherein water is present in a molar ratio of water to metal alkoxide in a range of from about 0.1:1 to about 10:1.

23. The process of claim 13, comprising after the polymerizing step the further step of drying the inorganic gel.

24. The process of claim 23, wherein the drying step is accomplished by heating the inorganic gel or removing the solvent from the inorganic gel.

25. The process of claim 23, comprising after the drying step the further step of calcinating the inorganic gel.

26. The process of claim 13, wherein the solvent is ethanol.

27. The process of claim 26, wherein ethanol is present in a molar ratio of ethanol to metal alkoxide in a range of from about 5:1 to about 53:1.

28. The process of claim 13, wherein the mixture has a pH in a range of from about 1 to about 12.

29. A fuel cell comprising a chamber, a membrane separating the chamber into an anode compartment and a cathode compartment, wherein the membrane is at least partially coated with a catalyst comprising a sol-gel derived composite comprising at least one noble metal and at least one electrically conductive component dispersed in and distributed throughout a matrix comprising titanium silicon sol-gel derived material, zirconium silicon sol-gel derived material, or mixtures thereof.

30. The fuel cell of claim 29, wherein the membrane comprises a first surface facing the anode chamber and a second surface facing the cathode chamber and wherein the catalyst is at least partially coated on the first surface.

31. The fuel cell of claim 29, wherein the fuel cell is a direct methanol fuel cell.

32. A fuel cell stack comprising at least two fuel cells, wherein at least one of the at least two fuel cells comprises the fuel cell of claim 29.

33. A membrane electrode assembly comprising:
a) a first electrode;
b) a second electrode; and
c) a solid polymer electrolyte membrane interposed between the first and second electrode;
wherein a sol-gel derived composite comprising at least one noble metal and at least one electrically conductive component dispersed in and distributed throughout a matrix comprising titanium silicon sol-gel derived material, zirconium silicon sol-gel derived material, or mixtures thereof is disposed at the interface between the first electrode and the solid polymer electrolyte membrane.

34. The membrane electrode assembly of claim 33, wherein the first electrode is an anode.

35. The membrane electrode assembly of claim 33, wherein the sol-gel derived composite is coated on the surface of the first electrode facing the solid polymer electrolyte membrane, the surface of the solid polymer electrolyte membrane facing the first electrode, or combinations thereof.

36. The membrane electrode assembly of claim 33, wherein a sol-gel derived composite comprising at least one noble metal and at least one electrically conductive component is disposed at the interface between the second electrode and the solid polymer electrolyte membrane.

37. The membrane electrode assembly of claim 36, wherein the sol-gel derived composite is coated on the surface of the first electrode facing the solid polymer electrolyte membrane and the surface of the second electrode facing the solid polymer electrolyte, both surfaces of the solid polymer electrolyte membrane, or combinations thereof.
